(19) United States
(12) Patent Application Publication
(10) Pub. No.: US 2017/0123699 A1
(43) Pub. Date: May 4, 2017

(54) STORAGE CONTROL DEVICE

(71) Applicant: FUJITSU LIMITED, Kawasaki-shi (JP)

(72) Inventors: Takahiro Ohyama, Kawasaki (JP); Akihito Kobayashi, Kawasaki (JP); Motohiro Sakai, Nerima (JP); Shinichiro Matsumura, Kawasaki (JP); Takuro Kumabe, Kawasaki (JP)

(73) Assignee: FUJITSU LIMITED, Kawasaki-shi (JP)

(21) Appl. No.: 15/298,680

(22) Filed: Oct. 20, 2016

(30) Foreign Application Priority Data
Nov. 2, 2015 (JP) 2015-215460

(51) Int. Cl. G06F 3/06

(52) U.S. Cl. CPC G06F 3/0619; G06F 3/0689; G06F 3/0665

(57) ABSTRACT

A storage control device is one of a plurality of control devices each controlling different storage areas. The storage control device includes a memory and a processor coupled to the memory. The processor is configured to acquire an allocation request for allocating a storage area to a first virtual volume. The processor is configured to allocate a first storage area to the first virtual volume upon acquiring the allocation request. The first storage area is controlled by a first control device among the plurality of control devices. The first control device controls the first virtual volume.

### CROSS-REFERENCE TO RELATED APPLICATION

This application is based upon and claims the benefit of priority of the prior Japanese Patent Application No. 2015-215460, filed on Nov. 2, 2015, the entire contents of which are incorporated herein by reference.

### FIELD

The embodiment discussed herein is related to a storage control device.

### BACKGROUND

There is a technology called thin provisioning that provides a virtual volume having a capacity greater than or equal to a storage capacity of a physical storage area. For example, there is a technology in which a determination as to which one of a first and second storage control devices performs a predetermined function is made, based on a situation of each of the storage control devices and functions which may be performed in each of the storage control devices, in a case where the predetermined function is requested to be performed from an upper level device. Furthermore, there is a technology for retrieving a real storage, which is existing physically, to be transferred across storage pools in consideration of a storage capacity of respective real storages, controllers in charge of an access control for the respective real storages, a storage capacity of a virtual storage on the real storages, and a destination of migrating data of the virtual storage.

Related techniques are disclosed in, for example, Japanese Laid-Open Patent Publication No. 2010-238131 and Japanese Laid-Open Patent Publication No. 2007-199891.

### SUMMARY

According to an aspect of the present invention, provided is a storage control device which is one of a plurality of control devices each controlling different storage areas. The storage control device includes a memory and a processor coupled to the memory. The processor is configured to acquire an allocation request for allocating a storage area to a first virtual volume. The processor is configured to allocate a first storage area to the first virtual volume upon acquiring the allocation request. The first storage area is controlled by a first control device among the plurality of control devices. The first control device controls the first virtual volume.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of operations of storage control devices 101#0 to 101#3 according to an embodiment;

FIG. 2 is a diagram illustrating an exemplary configuration of a storage system 200;

FIG. 3 is a diagram illustrating an exemplary hardware configuration of a CM 214;

FIG. 4 is a diagram illustrating an example of allocation by a TPP equalization mode;

FIG. 5 is a diagram illustrating an example of allocation by a TPV equalization mode;

FIG. 6 is a diagram illustrating an example of allocation according to the embodiment;

FIG. 7 is a diagram illustrating an exemplary functional configuration of a CM 214;

FIG. 8 is a diagram illustrating an example of I/O processing in a case where a Receive CM, an OLU representative CM, and a physical-storage control CM are different from each other;

FIG. 9 is a diagram illustrating an example of I/O processing in a case where an OLU representative CM and a physical-storage control CM are the same and different from a Receive CM;

FIG. 10 is a diagram illustrating an example of I/O processing in a case where a Receive CM and a physical-storage control CM are the same and different from an OLU representative CM;

FIG. 11 is a diagram illustrating an example of I/O processing in a case where a Receive CM and an OLU representative CM are the same and different from a physical-storage control CM;

FIG. 12 is a diagram illustrating an example of I/O processing in a case where all of a Receive CM, an OLU representative CM, and a physical-storage control CM are the same; and

FIG. 13 is a flowchart illustrating an example of physical area allocation processing for a write I/O.

### DESCRIPTION OF EMBODIMENT

In related arts, when an access is made to a virtual volume to which any one of storage areas is allocated among a plurality of storage control devices each controlling different storage areas, the communications between the plurality of storage control devices tends to be increased. For example, in a case where a storage control device controlling the virtual volume and a storage control device controlling the storage area allocated to the virtual volume are different, the communications are generated between the two storage control devices when an access is made to the virtual volume.

Hereinafter, detailed descriptions will be made on an embodiment of a storage control device of the present disclosure with reference to the accompanying drawings.

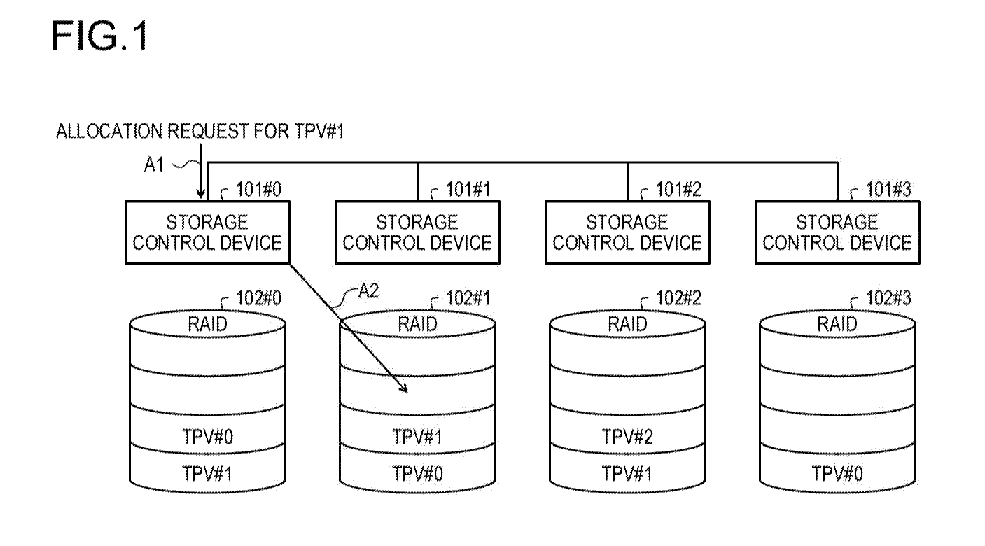

FIG. 1 is a diagram illustrating an example of operations of storage control devices 101#0 to 101#3 according to an embodiment. The storage control devices 101#0 to 101#3 are computers that control the physical areas 102#0 to 102#3 which are real storage areas, respectively. The storage control devices 101#0 to 101#3 provide a virtual volume by the thin provisioning to a host computer that uses the storage control devices 101#0 to 101#3. Hereinafter, the host computer is referred to as a “host”. The host is a server such as, for example, a web server and a database server.

The thin provisioning is a technology of providing a virtual volume having a capacity greater than or equal to a storage capacity of a physical storage area. A logical unit number (LUN) virtualized by the thin provisioning function is called a thin provisioning volume (TPV). A management unit obtained by dividing the TPV for each predetermined logical block size is called a chunk. TPVs are prepared in a thin provisioning pool (TPP) formed with a predetermined number of redundant array of inexpensive disks (RAID) groups. The storage control devices 101#0 to 101#3 control the TPVs of which each of the storage control devices 101#0 to 101#3 is in charge.

A RAID group is a set of storage devices forming a volume virtualized by a RAID technology. The RAID technology is a technology that combines a plurality of storage devices to operate the storage devices as a virtual volume. The RAIDs are assigned with RAID levels each indicating a method of forming a virtualized volume. The RAID levels include levels of RAID0 to RAID6. The RAID levels also include levels, such as RAID0+1, which are obtained by combining a plurality of RAID levels. Any RAID level may be applied with the embodiment.

In the example of FIG. 1, each of the physical areas 102#0 to 102#3 is a volume formed by a RAID group. The physical areas 102#0 to 102#3 form a single TPP. The RAID levels of the physical areas 102#0 to 102#3 may be the same and may be different from each other. Each of the physical areas 102#0 to 102#3 may be a single physical storage device. The physical areas 102#0 to 102#3 may be mixed in such a way that one of the physical areas 102#0 to 102#3 is a volume formed by a RAID group and another one is a single physical storage device.

Here, it is assumed that data writing is performed to a TPV from a host. In this case, among the storage control devices 101#0 to 101#3, a storage control device 101 which controls the allocation allocates, to a logical area for each chunk, a physical area appropriate to an amount of data, which is written by the host, from a RAID group within a TPP. In a case where all logical areas of a range within which the writing is to be performed are already allocated with physical areas, the storage control device 101 which controls the allocation does not newly allocate a physical area. No physical area is allocated to any chunk immediately after a TPV is prepared by the thin provisioning function. Thus, an allocated amount of physical areas for a TPV varies depending on a usage state of the TPV.

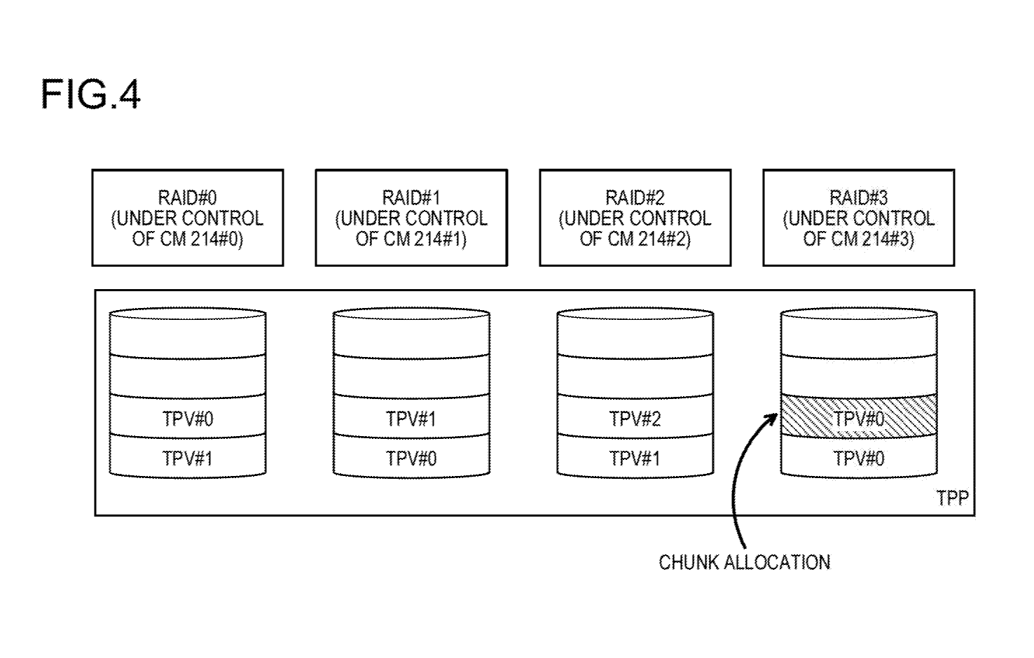

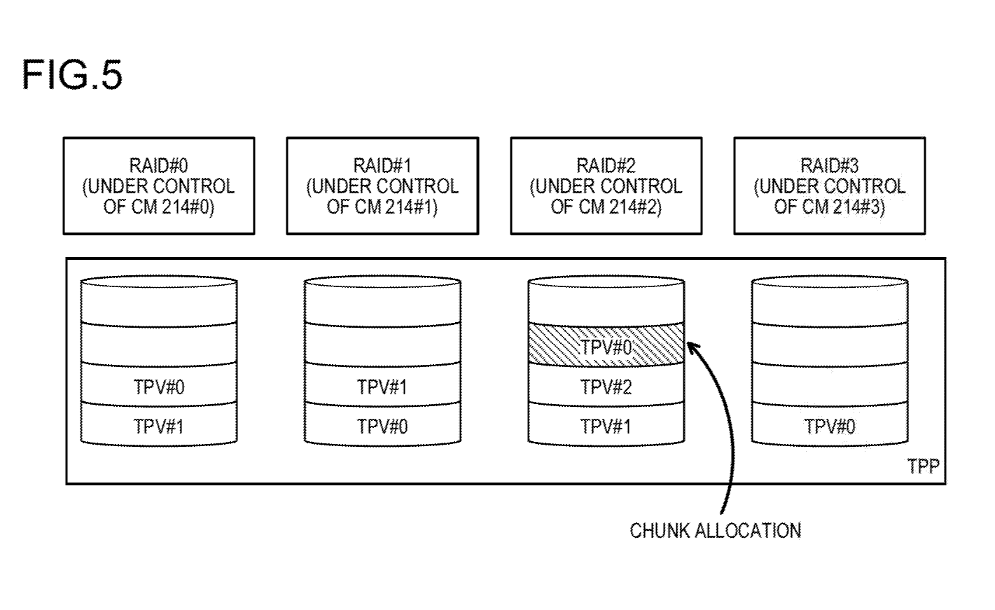

In a case where some logical areas of the range within which the writing is to be performed are not yet allocated with physical areas, physical areas are allocated to each chunk of the logical areas. A method in a TPP equalization mode and a method in a TPV equalization mode are considered as a method for allocating a physical area to a chunk. Details of the TPP equalization mode will be described later with reference to FIG. 4. Details of the TPV equalization mode will be described later with reference to FIG. 5.

However, even though any of the method in the TPP equalization mode and the method in the TPV equalization mode is performed, the communications between the plurality of storage control devices are increased during I/O processing. Specifically, in a case where a storage control device which controls a TPV is different from a storage control device which controls a physical area allocated to the TPV, communications are generated between the two storage control devices when an access is made to a virtual volume.

Accordingly, in the embodiment, descriptions will be made on matters that a physical area 102 controlled by a storage control device 101 which controls a TPV is allocated to a chunk of the TPV.

Hereinafter, descriptions will be made on an example of operations of the storage control devices 101#0 to 101#3 with reference to FIG. 1. In the example of FIG. 1, it is assumed that the storage control device 101 which controls the allocation is the storage control device 101#0. Also, it is assumed that the storage control device 101#0 controls a TPV#0, the storage control device 101#1 controls a TPV#1, and the storage control device 101#2 controls a TPV#2. In the example of FIG. 1, it is further assumed that each of the physical areas 102#0 to 102#3 has four segments.

In this state, the storage control device 101#0 acquires an allocation request for a chunk of the TPV#1 (A1 in FIG. 1). For example, when a write request to the TPV#1 is received from the host, the storage control device 101#1 which controls the TPV#1 creates an allocation request for a new physical area in a case where a physical area is not yet allocated to the logical area for the write request. The storage control device 101#1 transmits the created allocation request to the storage control device 101#0. In this case, the storage control device 101#0 acquires the allocation request for a chunk of the TPV#1 from the storage control device 101#1.

In addition, although it is different from the example of FIG. 1, when a write request to the TPV#0 is received, the storage control device 101#0 which controls the TPV#0 creates an allocation request for a new physical area in a case where a physical area is not yet allocated to the logical area for the write request. In this case, the storage control device 101#0 acquires the allocation request for a chunk of the TPV#0 from the storage control device 101#0 by creating the allocation request.

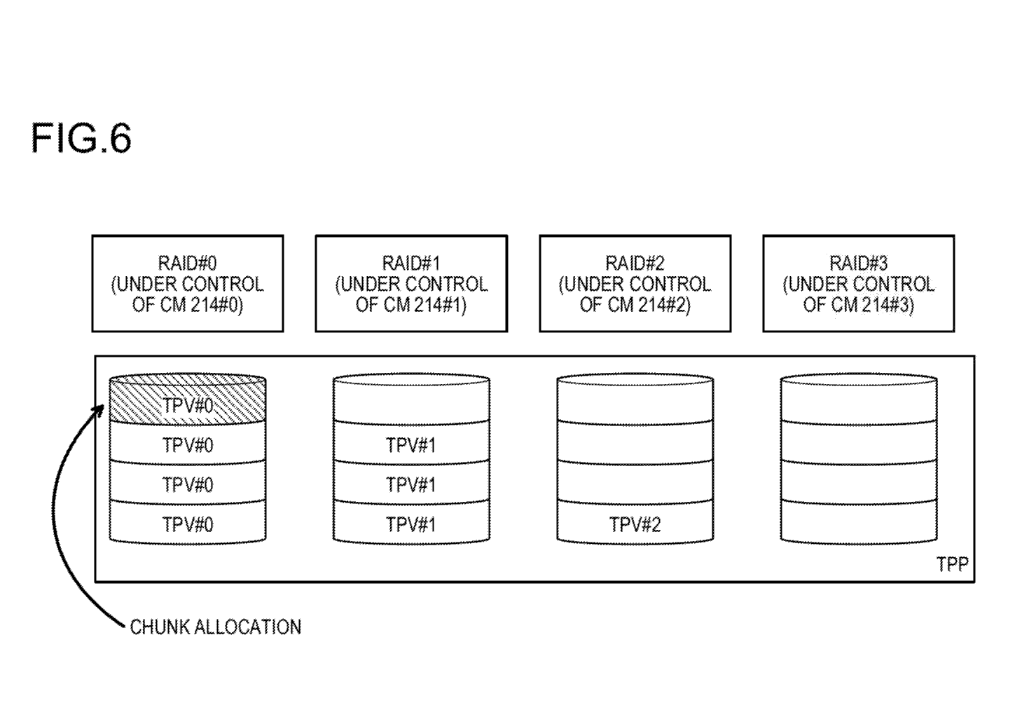

In a case where the allocation request to TPV#1 is acquired, the storage control device 101#0 allocates the physical area 102#1, which is controlled by the storage control device 101#1 which controls the TPV#1, to the TPV#1 (A2 in FIG. 1). An example of allocation according to the embodiment is illustrated in FIG. 6. Specifically, in the example of FIG. 1, the storage control device 101#0 transmits an instruction to allocate the physical area 102#1 to the TPV#1 to the storage control device 101#1. The storage control device 101#1 allocates one segment of the physical area 102#1 for the chunk of the TPV#1 in accordance with the instruction.

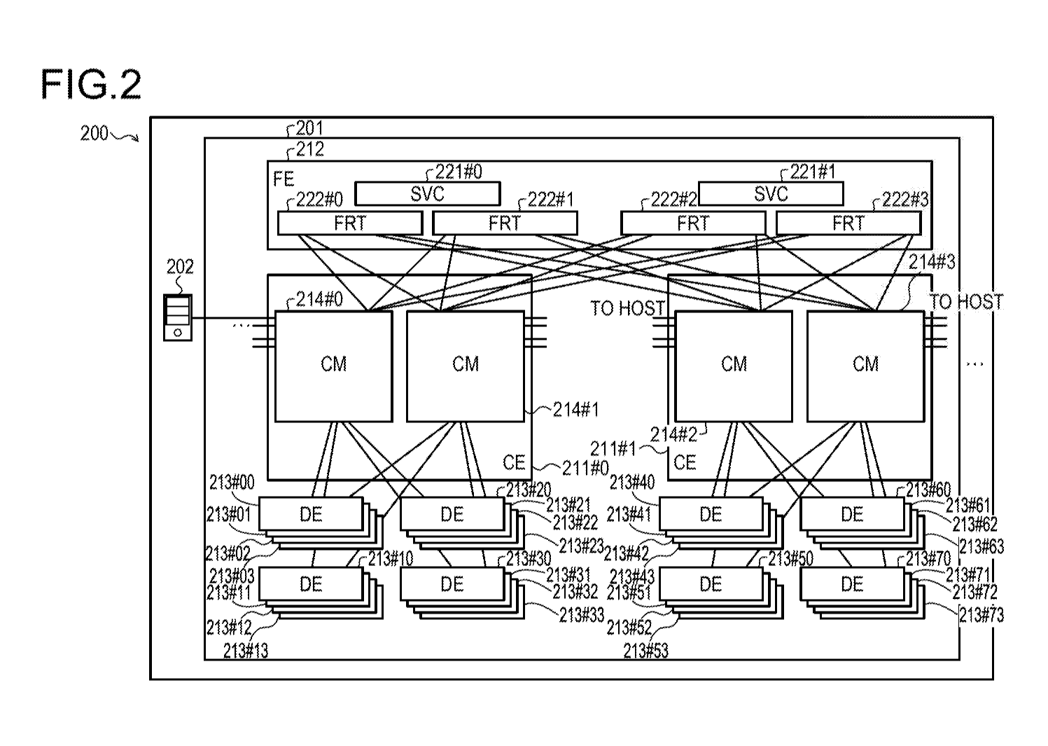

Accordingly, in the I/O processing to the TPV#1, the storage control device 101 which controls the TPV#1 and the storage control device 101 which controls the physical area 102 allocated to the TPV#1 become the same. Accordingly, the communications between the storage control devices 101 may be reduced and the overhead due to the communications may be reduced. Next, with reference to FIG. 2, descriptions will be made on an example in which the storage control devices 101#0 to 101#3 illustrated in FIG. 1 are applied to a storage system.

FIG. 2 is a diagram illustrating an exemplary configuration of a storage system 200. With reference to FIG. 2, descriptions will be made on an exemplary configuration of the storage system 200. The storage system 200 includes a disk array device 201 and a host 202. The disk array device 201 includes controller enclosures (CEs) 211#0, 211#1, . . . , a frontend enclosure (FE) 212, and drive enclosures (DEs) 213#00 to 213#73. The CE 211 includes a controller module (CM) 214. Specifically, the CE 211#0 includes CMs 214#0 and 214#1, and a CE 211#1 includes CMs 214#2 and 214#3. The CM 214 corresponds to the storage control device 101 described in FIG. 1.

The host 202 is an apparatus which use TPVs. For example, the host 202 issues an I/O command such as, for example, for a read access or a write access, to a TPV.

The FE 212 includes service controllers (SVCs) 221#0 and 221#1 and frontend routers (FRTs) 222#0 to 222#3. The SVC 221 is a unit that performs a system management. The FRT 222 is a module that provides a communication path between the CMs.

The DEs 213#00 to 213#73 are cases accommodating a plurality of disks. Here, the disks accommodated in the DE 213 are, for example, hard disk drives (HDDs). The DEs 213#00 to 213#73 may accommodate solid state drives (SSDs) or the HDDs and the SSDs may be mixed to be incorporated. The disks to be accommodated in the DE 213 may have the same storage capacity or different storage capacities from each other.

The CM 214 forms the TPV using the disks accommodated in the DE 213. Each TPV of a plurality of TPVs has a CM by which each TPV is controlled. In the following description, a CM which controls a TPV is referred to as an “open LUN unit (OLU) representative CM” of the TPV. A single CM 214 may control a single TPV or a plurality of TPVs.

Each RAID group within the TPP has a CM by which each RAID group is controlled. In the following description, the CM which controls a RAID group is referred to as a “physical-storage control CM”. For example, when a RAID level of a RAID group under the control of a physical-storage control CM is RAIDS, the CM calculates a parity upon receiving a write request and writes data and the parity in each disk of the RAID group. A single CM 214 may control a single RAID group or a plurality of RAID groups.

In the following description, the CM which receives an access from the host 202 is referred to as a “Receive CM”.

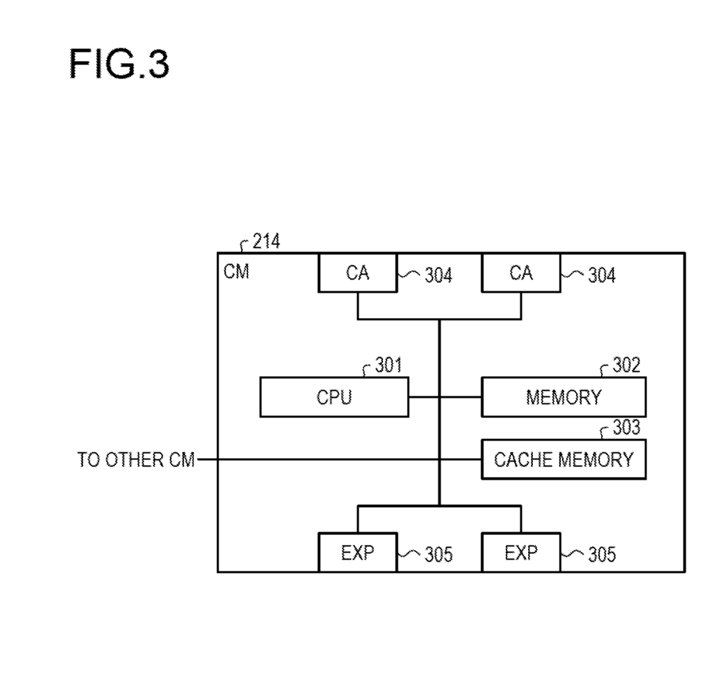

FIG. 3 is a diagram illustrating an exemplary hardware configuration of the CM 214. The CM 214 includes a central processing unit (CPU) 301, a memory 302, a cache memory 303, a channel adaptor (CA) 304, and an expander (EXP) 305. The CPU 301, the memory 302, the cache memory 303, the CA 304, and the EXP 305 are coupled to each other.

The CPU 301 is an arithmetic processing device responsible for control of the entire CM 214. The CPU 301 may be a multi-core processor having a plurality of cores. The memory 302 is a volatile memory used as a work area of the CPU 301. The cache memory 303 has an access performance higher than the memory 302 and stores therein a portion of the memory 302.

The CA 304 is a communication interface for communicating with the host 202. The CM 214, as illustrated in FIG. 3, may include a plurality of CAs 304 to have a redundant configuration of the CAs 304.

The EXP 305 is an Expander chip for a connection of SAS (Serial Attached SCSI (Small Computer System Interface))/SATA (Serial ATA (Advanced Technology Attachment)). The CM 214, as illustrated in the example of FIG. 3, may include a plurality of EXPs 305 to have a redundant configuration of the EXPs 305.

With reference to FIG. 4 to FIG. 6, descriptions will be made on examples of allocation by the TPP equalization mode, by the TPV equalization mode, and according to the embodiment, respectively. In FIG. 4 to FIG. 6, it is assumed that four CMs 214#0 to 214#3 exist, three TPVs of TPV#0 to TPV#2 exist, and four RAID groups of RAID#0 to RAID#3 exist. The RAID#0 to RAID#3 are RAID groups formed by a plurality of disks within the DE 213.

It is assumed that the OLU representative CM of the TPV#0 is a CM 214#0, the OLU representative CM of the TPV#1 is a CM 214#1, and the OLU representative CM of the TPV#2 is a CM 214#2. Also, it is assumed that the physical-storage control CM of the RAID#0 is the CM 214#0, the physical-storage control CM of the RAID#1 is the CM 214#1, the physical-storage control CM of the RAID#2 is the CM 214#2, and the physical-storage control CM of the RAID#3 is the CM 214#3.

In the examples of FIG. 4 to FIG. 6, it is assumed that each of the RAID#0 to RAID#3 includes four segments obtained by dividing the physical area. In the examples of FIG. 4 and FIG. 5, it is assumed that two segments are allocated to a single chunk of each of the TPV#0 and TPV#1 in the RAID#0 and the RAID#1, that two segments are allocated to a single chunk of each of the TPV#1 and TPV#2 in the RAID#2, and that a single segment is allocated to a single chunk of the TPV#0 in the RAID#3.

In the example of FIG. 6, it is assumed that three segments are allocated to three chunks of the TPV#0 in the RAID#0, that three segments are allocated to three chunks of the TPV#1 in the RAID#1, and that a single segment is allocated to a single chunk of the TPV#2 in the RAID#2. In the examples of FIG. 4 to FIG. 6, it is assumed that a new segment is to be allocated to the TPV#0.

FIG. 4 is a diagram illustrating an example of allocation by the TPP equalization mode. In the TPP equalization mode, a new segment to be allocated to a TPV is selected so as to allow the RAID groups within the TPP to be equally used for entire TPP including other TPVs, that is, the physical areas are to be disposed to be balanced in the entire TPP.

In the example of FIG. 4, two segments are allocated to two chunks of the TPV in the RAID#0, the RAID#1, and the RAID#2, and a single segment is allocated to a single chunk of the TPV in the RAID#3. In this case, in accordance with the TPP equalization mode, the CM, which controls the allocation, allocates a physical area of the RAID#3 to a chunk of the TPV#0 in order to make the physical areas to be balanced in the TPP.

FIG. 5 is a diagram illustrating an example of allocation by the TPV equalization mode. In the TPV equalization mode, a new segment to be allocated to a TPV is selected so as to allow a RAID group within the TPP to be equally used for the TPV, that is, the physical areas are to be disposed to be balanced in the TPV.

In the example of FIG. 5, a single physical area of each of the RAID#0, the RAID#1, and the RAID#3 is allocated to each chunk of the TPV#0 for which the allocation request has been made. In this case, in accordance with the TPV equalization mode, a CM (allocation control CM) which controls the allocation allocates a physical area of the RAID#2 to a chunk of the TPV#0 in order to make the physical areas to be balanced in the TPV.

FIG. 6 is a diagram illustrating an example of allocation according to the embodiment. In the example of FIG. 6, according to the embodiment, the allocation control CM allocates a segment of the RAID#0 controlled by the CM 214#0, which is the OLU representative CM of the TPV#0, to a chunk of the TPV#0.

In the method illustrated in FIG. 4 and FIG. 5, a segment is allocated irrespective of the OLU representative CM. For that reason, when the OLU representative CM and the physical-storage control CM are different in I/O processing, the number of times of communications (inter-CM communications) between the CMs in the processing is increased, and thus an overhead may be generated. In contrast, according to the method illustrated in FIG. 6, since the OLU representative CM and the physical-storage control CM is the same, the number of times of inter-CM communications in the processing is decreased, and thus the overhead may be suppressed. In a multipath environment, when a function causing the physical-storage control CM of a physical area allocated to the chunk and the Receive CM to be the same is valid, the function may be also used in combination so as to make it possible to further reduce inter-CM communications.

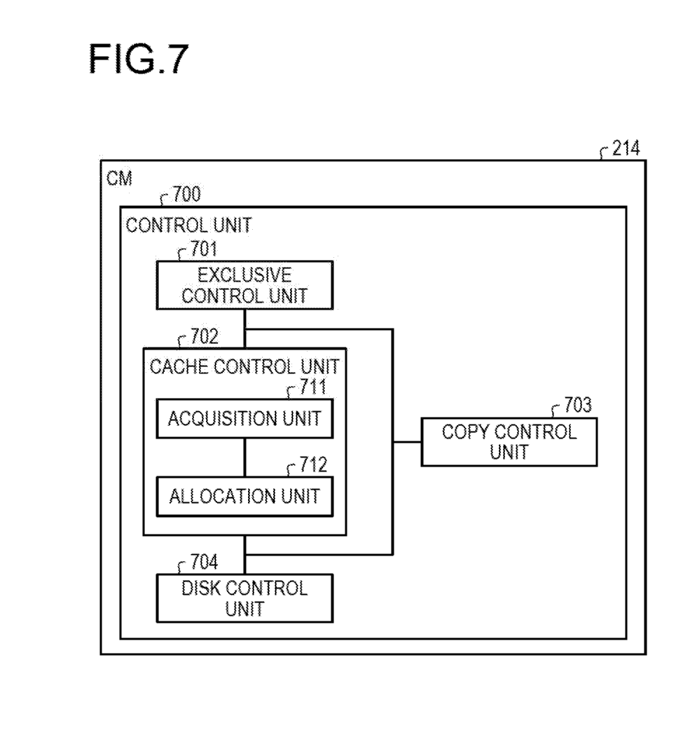

When a case where multiple TPVs exist is considered, the allocation of the physical areas is not biased toward a certain RAID group, the physical areas are equally allocated in the entire TPP, and thus the load on the CM is distributed. Next, with reference to FIG. 7, descriptions will be made on the functions equipped in the CM 214.

FIG. 7 is a diagram illustrating an exemplary functional configuration of the CM 214. The CM 214 includes a control unit 700. The control unit 700 includes an exclusive control unit 701, a cache control unit 702, a copy control unit 703, and a disk control unit 704. The cache control unit 702 includes an acquisition unit 711 and an allocation unit 712. The functions of the respective units in the control unit 700 are implemented through execution of a program stored in a storage device by the CPU 301. The storage device includes the memory 302, a storage device within the DE 213, and the like. Processing results of the respective units are stored in registers of the CPU 301, the cache memory 303, or the like.

The exclusive control unit 701 performs exclusive acquisition processing in an I/O range (Extent-exclusion acquisition processing) and exclusive release processing in an I/O range (Extent-exclusion release processing).

The cache control unit 702 performs cache acquisition processing and cache release processing for the cache memory 303.

The copy control unit 703 copies data within the disk array device 201. For example, the copy control unit 703 copies data of a certain volume within the disk array device 201 to another volume for a backup.

The disk control unit 704 controls a plurality of disks of the DE 213. The acquisition unit 711 acquires an allocation request to a chunk of a TPV.

In a case where the acquisition unit 711 acquires the allocation request, the allocation unit 712 allocates a physical area controlled by the OLU representative CM of a TPV for which the allocation request is made, among the CMs 214#0 to 214#3, to the chunk of the TPV.

For example, in a case where the acquisition unit 711 acquires the allocation request, when an already-allocated amount of the physical areas controlled by the OLU representative CM is less than or equal to a predetermined threshold, the allocation unit 712 allocates a physical area controlled by the OLU representative CM to the chunk of the TPV. In a case where the acquisition unit 711 acquires the allocation request, when the already-allocated amount of the physical areas controlled by the OLU representative CM is greater than the predetermined threshold, the allocation unit 712 allocates a physical area controlled by the Receive CM among the CMs 214#0 to 214#3 to the chunk of the TPV.

Hereinafter, the predetermined threshold is referred to as an “allocation-amount threshold”. For example, the allocation-amount threshold may be a certain ratio to the physical area under the control of the OLU representative CM. Specifically, a value of a ninety percent or an eighty percent of a storage capacity of the entire physical area under the control of the OLU representative CM may be set as the allocation-amount threshold for the CM 214 by an administrator of the storage system 200.

The allocation-amount threshold may be a value obtained by adding a predetermined value to the minimum value of the already-allocated amounts of the physical areas under the control of the respective CMs 214. For the sake of brevity of description, it is assumed that the storage capacities of the physical areas under the control of the respective CMs 214 are the same. When the minimum value of the already-allocated amount of the physical areas under the control of the respective CMs 214 is twenty percent of the storage capacity of the entire physical area, a value obtained by adding the predetermined value, for example, ten percent or twenty percent, to the twenty percent is set for the CM 214 as the allocation-amount threshold. Accordingly, the already-allocated amount may be suppressed from being significantly biased between the respective CMs 214.

When the already-allocated amount of the physical areas controlled by the Receive CM is greater than the allocation-amount threshold, the allocation unit 712 may allocate a physical area of a CM, of which the already-allocated amount is the smallest among the CM 214#0 to the CM 214#3, to the chunk of the TPV.

Furthermore, the function described above may also be applied to a re-allocation to a chunk of a TPV. For example, a situation where the re-allocation is performed is a situation where the already-allocated amount of the physical areas under the control of the OLU representative CM becomes greater than the allocation-amount threshold first and then a physical area of the CM of which the already-allocated amount is smallest is allocated. Thereafter, the already-allocated amount of the physical areas under the control of the OLU representative CM may become less than or equal to the allocation-amount threshold due to, for example, a fact that the data of the TPV is deleted and thus allocation is released. In this case, the CM 214 may perform the re-allocation to the chunk of the TPV so as to reduce inter-CM communications.

In a case where the re-allocation is performed, the acquisition unit 711 acquires a migration request for data stored in a physical area, which is allocated to a chunk of a certain TPV, among the physical areas controlled by a CM among the CM 214#0 to CM 214#3, which is different from the OLU representative CM of the certain TPV. When the acquisition unit 711 acquires the migration request, the allocation unit 712 allocates a physical area controlled by the OLU representative CM of the certain TPV, which is the migration destination of the data for which the migration request has been made, to the chunk of the certain TPV. After the allocation, the CM 214 copies the data, for which the migration request has been made, to the migration destination.

Here, descriptions will be made on a specific example of the re-allocation, using an example after the segment of the RAID#3 is allocated to the chunk of the TPV#0 in FIG. 4. In a case of performing the re-allocation, the acquisition unit 711 acquires a migration request of data in a segment of the RAID#1, which is allocated to the chunk of the TPV#0 of the CM 214#1 which is different from the CM 214#0 serving as the OLU representative CM of the TPV#0 as the certain TPV. The allocation unit 712 allocates a segment controlled by the CM 214#0 serving as the OLU representative CM of the TPV#0, to the chunk of the TPV#0. After the allocation, the CM 214#0 writes the data of the segment, which has been allocated to the chunk of the TPV#0 of the RAID#1, to the segment within the RAID#0, which is allocated by the allocation unit 712.

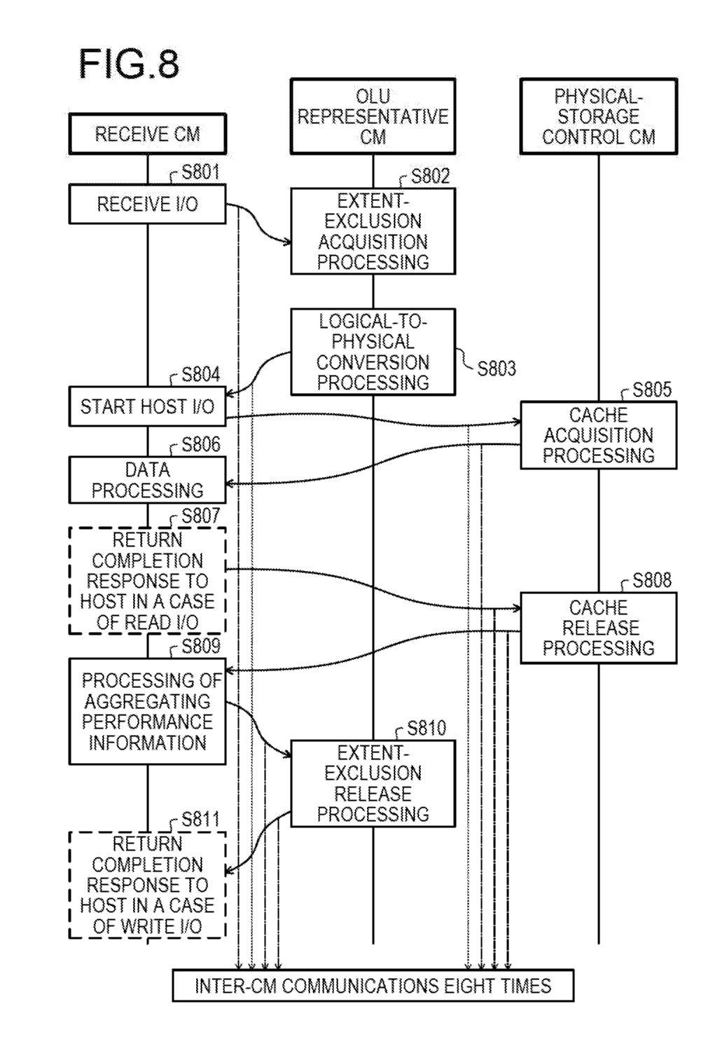

Next, with reference to FIG. 8 to FIG. 12, descriptions will be made on I/O processing in a case where three CMs of the Receive CM, the OLU representative CM, the physical-storage control CM are different from each other or the same. In FIG. 8 to FIG. 12, the solid line arrows between the CMs indicate inter-CM communications.

FIG. 8 is a diagram illustrating an example of I/O processing in a case where a Receive CM, an OLU representative CM, and a physical-storage control CM are different from each other. The Receive CM receives an I/O (S801). When the I/O is received, the Receive CM performs an inter-CM communication with respect to the OLU representative CM.

The OLU representative CM which has received the inter-CM communication performs the Extent-exclusion acquisition processing (S802). The OLU representative CM performs logical-to-physical conversion processing in which a physical area corresponding to a logical area is obtained (S803). Next, the OLU representative CM performs an inter-CM communication with respect to the Receive CM to return the process thereto.

The Receive CM which has received the inter-CM communication starts a host I/O (S804) and performs an inter-CM communication with respect to the physical-storage control CM which is in charge of the obtained physical area.

The physical-storage control CM which has received the inter-CM communication performs cache acquisition processing (S805). Here, the physical-storage control CM performs an inter-CM communication with respect to the Receive CM to return the process thereto.

The Receive CM which has received the inter-CM communication performs data processing (S806). The Receive CM returns a completion response to the host 202 in a case where the I/O received from the host 202 is a read I/O (S807). The Receive CM performs an inter-CM communication with respect to the physical-storage control CM after the S806 is ended when the I/O received from the host 202 is not a read I/O, or after the S807 is ended when the I/O received from the host 202 is a read I/O.

The physical-storage control CM which has received the inter-CM communication performs cache release processing (S808). The physical-storage control CM performs an inter-CM communication with respect to the Receive CM to return the process thereto.

The Receive CM which has received the inter-CM communication performs processing of aggregating performance information (S809). The Receive CM performs an inter-CM communication with respect to the OLU representative CM.

The OLU representative CM which has received the inter-CM communication performs the Extent-exclusion release processing (S810). Next, the OLU representative CM performs an inter-CM communication with respect to the Receive CM to return the process thereto.

The Receive CM which has received the inter-CM communication returns a completion response to the host 202 in a case where the I/O received from the host 202 is a write I/O (S811). As described above, in a case of FIG. 8, the number of times of inter-CM communications becomes eight times.

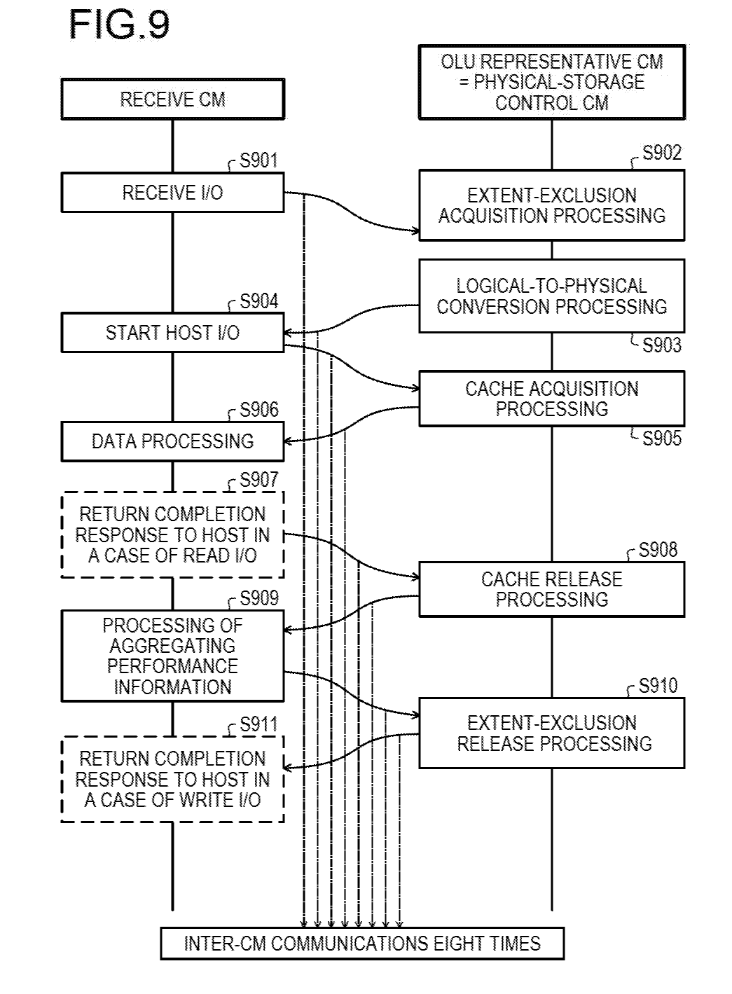

FIG. 9 is a diagram illustrating an example of I/O processing in a case where the OLU representative CM and the physical-storage control CM are the same and different from the Receive CM. S901 to S911 are the same as S801 to S811 and thus, descriptions thereof will be omitted. In a case where the OLU representative CM and the physical-storage control CM are the same, the number of times of inter-CM communications becomes eight times, which is the same as in FIG. 8.

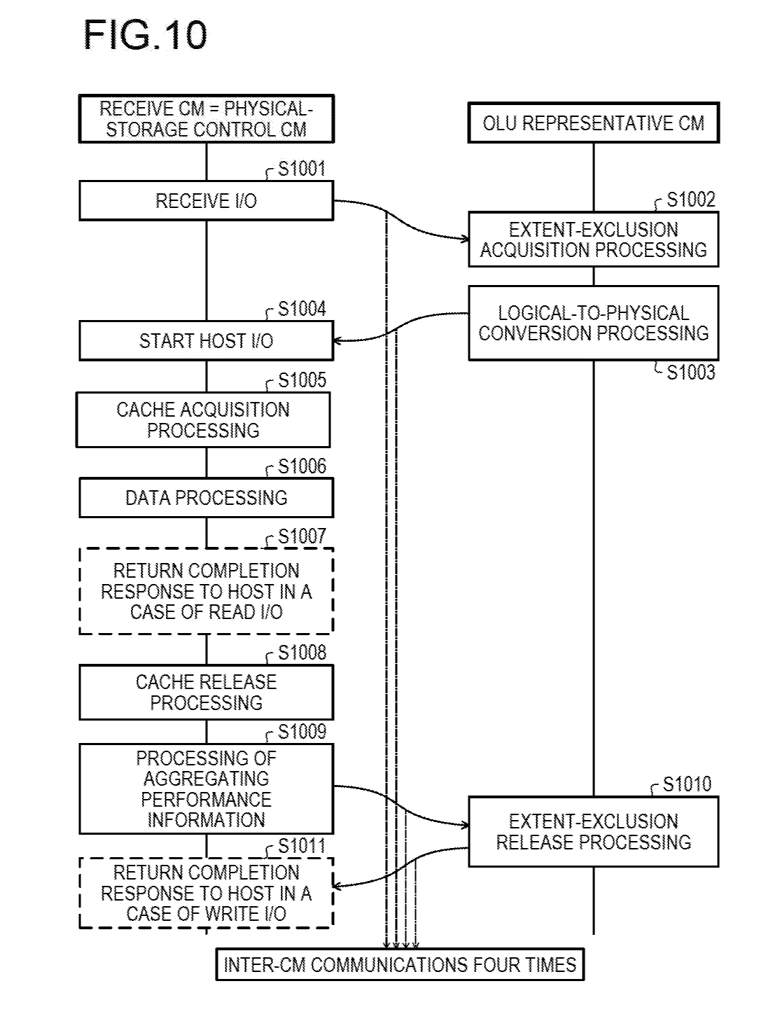

FIG. 10 is a diagram illustrating an example of I/O processing in a case where the Receive CM and the physical-storage control CM are the same and different from the OLU representative CM. S1001 to S1011 are the same as S801 to S811 and thus, descriptions thereof will be omitted. In a case where the Receive CM and the physical-storage control CM are the same, the inter-CM communication does not need to be performed S1004 to S1006 and S1007 to S1009. As described above, in a case illustrated in FIG. 10, the number of times of inter-CM communications becomes four times.

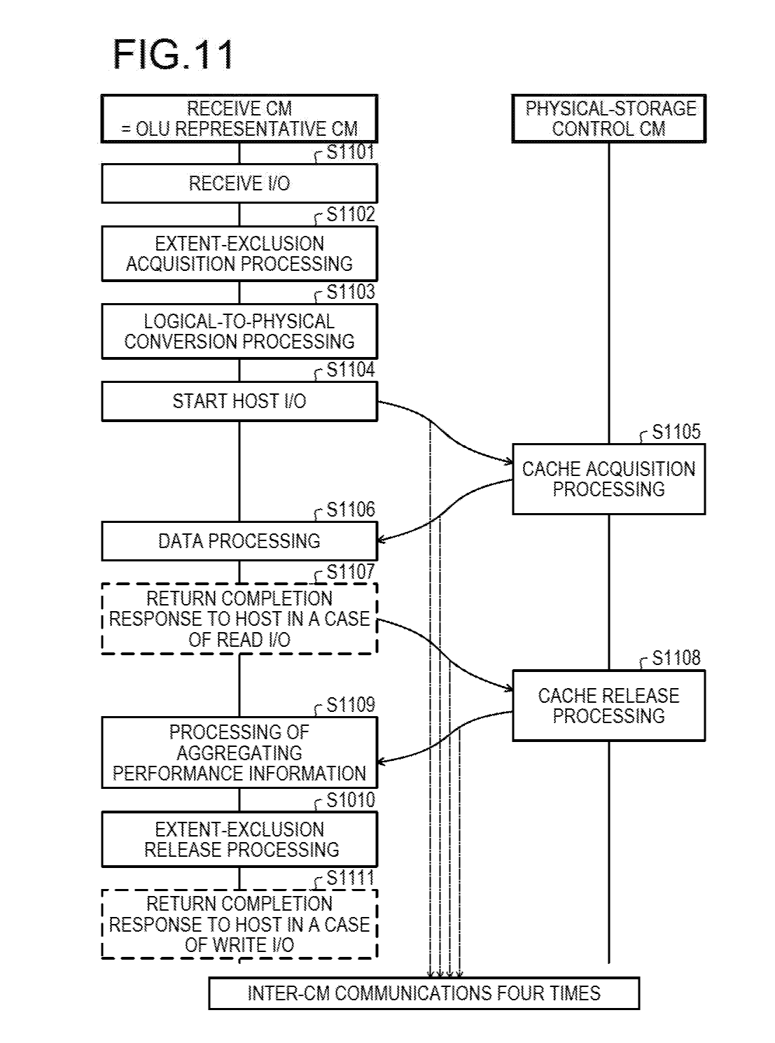

FIG. 11 is a diagram illustrating an example of I/O processing in a case where the Receive CM and the OLU representative CM are the same and different from the physical-storage control CM. S1101 to S1111 are the same as S801 to S811 and thus, descriptions thereof will be omitted. In a case where the Receive CM and the OLU representative CM are the same, the inter-CM communication does not need to be performed between S1101 and S1102, between S1103 and S1104, and S1109 to S1111. As described above, in a case illustrated in FIG. 11, the number of times of inter-CM communications becomes four times.

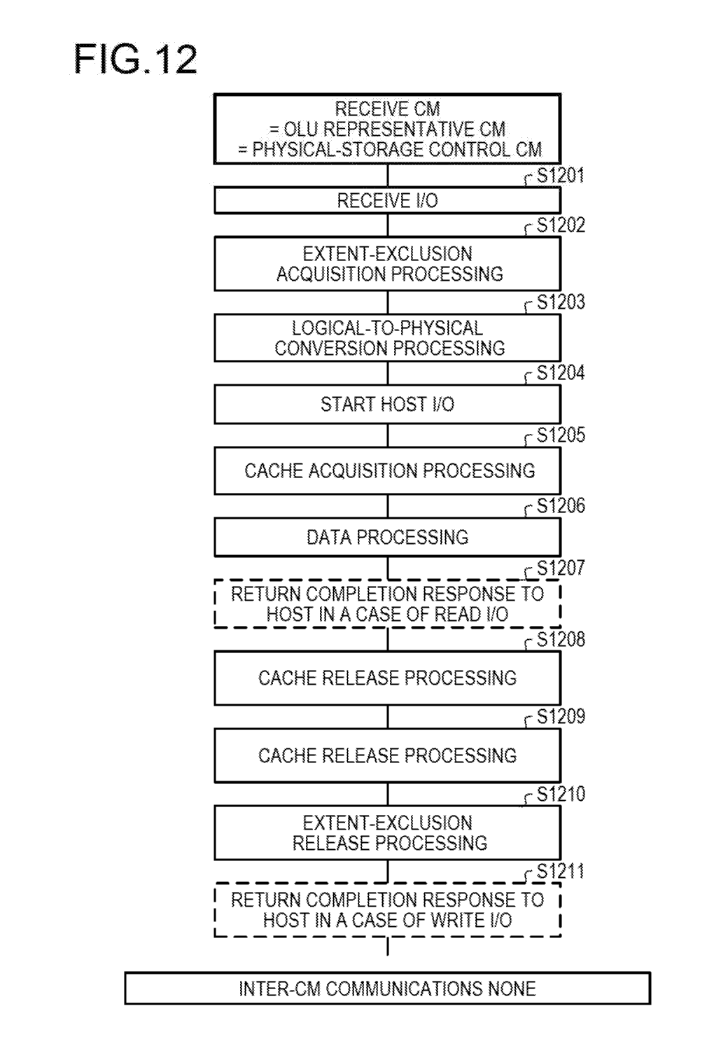

FIG. 12 is a diagram illustrating an example of I/O processing in a case where all of the Receive CM, the OLU representative CM, and the physical-storage control CM are the same. S1201 to S1211 are the same as S801 to S811 and thus, description thereof will be omitted. In a case where the Receive CM, the OLU representative CM, and the physical-storage control CM are the same, the inter-CM communication does not need to be performed in all of S1201 to S1211. As described above, in a case illustrated in FIG. 12, the number of times of inter-CM communications becomes none.

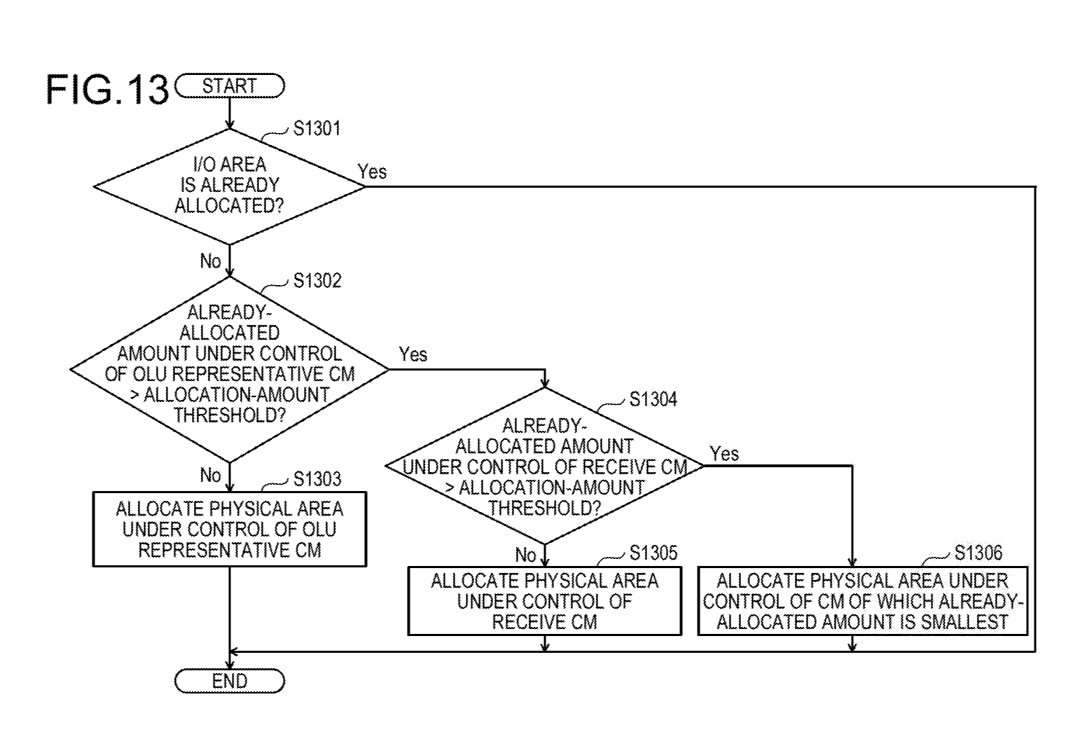

Next, with reference to FIG. 13, descriptions will be made on physical area allocation processing.

FIG. 13 is a flowchart illustrating an example of physical area allocation processing for a write I/O. The physical area allocation processing for a write I/O is processing performed when a write I/O is received. Here, in a case where the connection with the host 202 is a single path, a CM 214 coupled to the host 202 becomes the Receive CM. In a case where the connection with the host 202 is a multi-path and is in an Active/Active-preferred environment, a CM 214 coupled to the host 202 by a path of Active-preferred becomes the Receive CM. Here, the Active/Active-preferred environment refers to a state where any one of a plurality of valid paths is in a state of being set as a preferential path as the Active-preferred.

The OLU representative CM determines whether an area (I/O area) corresponding to a range for the I/O is already allocated (S1301). When it is determined that the I/O area is already allocated (“YES” at S1301), the disk array device 201 ends the physical area allocation processing for a write I/O.

When it is determined that the I/O area is not allocated yet (“NO” at S1301), a physical area is allocated to the I/O area. Therefore, the OLU representative CM issues an allocation request for the I/O area to an allocation control CM. The allocation control CM acquires the allocation request for the I/O area from the OLU representative CM. In a case where the allocation control CM and the OLU representative CM are the same, it is assumed that the allocation control CM creates the allocation request by itself and thus acquires the allocation request.

The allocation control CM determines whether an already-allocated amount under the control of the OLU representative CM exceeds the allocation-amount threshold (S1302). When it is determined that the already-allocated amount under the control of the OLU representative CM does not exceed the allocation-amount threshold (“NO” at S1302), the physical-storage control CM which has received the instruction from the allocation control CM allocates a physical area under the control of the OLU representative CM (S1303). In a case where the process of S1303 is performed, the OLU representative CM and the physical-storage control CM become the same and becomes in either one of a state illustrated in FIG. 9 or a state illustrated in FIG. 12.

When it is determined that the already-allocated amount under the control of the OLU representative CM exceeds the allocation-amount threshold (“YES” at S1302), the allocation control CM determines whether an already-allocated amount under control of the Receive CM exceeds the allocation-amount threshold (S1304). When it is determined that the already-allocated amount under the control of the Receive CM does not exceed the allocation-amount threshold (“NO” at S1304), the physical-storage control CM, which has received the instruction from the allocation control CM, allocates a physical area under the control of the Receive CM (S1305). In a case where the process of S1305 is performed, the Receive CM and the physical-storage control CM become the same and becomes in a state illustrated in FIG. 10.

When it is determined that the already-allocated amount under the control of the Receive CM exceeds the allocation-amount threshold (“YES” at S1304), the physical-storage control CM, which has received the instruction from the allocation control CM, allocates a physical area under the control of the CM of which an already-allocated amount is the smallest (S1306). In a case where the process of S1306 is performed, any one of states illustrated in FIG. 8 to FIG. 12 is made.

After any one of the processes of S1303, S1305, and S1306 is ended, the disk array device 201 ends the physical area allocation processing for a write I/O.

Although the flowchart illustrated in FIG. 13 illustrates allocation of a physical area in the write I/O, the flowchart may also be applied when re-allocation is performed. First, for example, the allocation control CM searches for a CM such that the already-allocated amount under the control thereof exceeds the allocation-amount threshold among all physical-storage control CMs. The allocation control CM determines whether there exists, among the physical areas under the control of the detected physical-storage control CM, a physical area allocated to a TPV other than the TPV under the control of the detected physical-storage control CM. When it is determined that there exists a physical area allocated to another TPV, the allocation control CM applies the process of S1302 and determines whether an already-allocated amount under the control of the OLU representative CM of the other TPV exceeds the allocation-amount threshold. Regarding the processing after the determination, the disk array device 201 performs the processes in accordance with the flowchart illustrated in FIG. 13 and allocates a physical area, which is to serve as the migration destination of data stored in the physical area allocated to a chunk of the other TPV, to the chunk of the other TPV.

After the physical area is allocated, the disk array device 201 copies the data, which is stored in the physical area allocated to the chunk of the other TPV under the control of the detected physical-storage control CM, to the physical area serving as the migration destination.

By the method for performing the physical area allocation processing for a write I/O according to the embodiment, the OLU representative CM may coincide with the physical-storage control CM as long as the already-allocated amount under the control of the OLU representative CM does not exceed the allocation-amount threshold. The number of inter-CM communications becomes eight times or none depending on a result of whether the OLU representative CM and the Receive CM are the same or different from each other. In contrast, the number of inter-CM communications becomes any one of eight times, eight times, four times, four times, or none in a method in which the physical-storage control CM is determined irrespective of the OLU representative CM. When comparing the two methods to each other, the method according to the embodiment may reduce the overhead of the inter-CM communications and thus, the I/O response may be made faster. In particular, in the method in which the physical-storage control CM is determined irrespective of the OLU representative CM, a possibility that the number of inter-CM communications becomes eight times may be higher as the number of CMs is increased, and the overhead of the inter-CM communications is increased.

An effect of the reduction of the inter-CM communications is significantly greater than the disadvantage of an increase in the load of the CM and thus, the method according to the embodiment contributes to enhancing the maximum performance in the I/O throughput.

As described above, when an allocation request for a physical area to a chunk of a TPV is acquired, the CM 214 allocates a physical area controlled by the OLU representative CM of the TPV, for which the allocation request is made, to the chunk of the TPV. Accordingly, the OLU representative CM and the physical-storage control CM become the same and thus, the CM 214 may reduce the number of inter-CM communications in accessing the TPV. The number of OLU representative CMs corresponding to the TPV is also increased as the number of the TPVs is increased and thus, the allocations may be distributed.

When an already-allocated amount of the physical areas controlled by the OLU representative CM is less than or equal to an allocation-amount threshold, the CM 214 may allocate a physical area controlled by the OLU representative CM of the TPV, for which the allocation request is made, to the chunk of the TPV. When the already-allocated amount of the physical areas controlled by the OLU representative CM is greater than the allocation-amount threshold, the CM 214 allocates a physical area controlled by the Receive CM to the chunk of the TPV. Accordingly, when a space exists in the already-allocated amount in the OLU representative CM, the OLU representative CM and the physical-storage control CM become the same and thus, the CM 214 may reduce the inter-CM communications in accessing the TPV. Even when there is no space in the already-allocated amount in the OLU representative CM, the Receive CM and the physical-storage control CM become the same and thus, the CM 214 may reduce the inter-CM communications in accessing the TPV.

When the already-allocated amount of the physical areas controlled by the Receive CM is greater than the allocation-amount threshold, the CM 214 may allocate a physical area of a CM, of which an already-allocated amount is the smallest, to the chunk of the TPV. Accordingly, the CM 214 may distribute the allocations.

The CM 214 may allocate a physical area controlled by the OLU representative CM of a certain TPV as the migration destination of data stored in a physical area which is allocated to a chunk of the certain TPV among physical areas controlled by a CM different from the OLU representative CM of the certain TPV. Accordingly, even though a physical area is temporarily allocated to increase the inter-CM communications, the CM 214 may reduce, by the re-allocation, the number of inter-CM communications in accessing the TPV.

The physical area controlled by each CM may be a volume formed by a RAID group. According to the embodiment, each RAID group is subjected to processing appropriate to the RAID level, and a CM that performs the control is set in each RAID group in order to distribute the load caused by the processing according to the RAID level. According to the embodiment, two controls of a logical side control by the OLU representative CM and a physical side control by the physical-storage control CM exist in accessing the physical area, and the two controls are performed by the same CM and thus, the number of inter-CM communications may be reduced.

The storage control method described in the embodiment may be implemented by causing a computer such as, for example, a personal computer or a workstation to execute a prepared program. The storage control program is recorded in a computer-readable recording medium such as, for example, a hard disk, a flexible disk, a compact disc read-only memory (CD-ROM), a digital versatile disk (DVD), and is executed when read from the recording medium by the computer. The storage control program may be distributed through a network such as, for example, the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device which is one of a plurality of control devices each controlling different storage areas, the storage control device comprising:
a memory; and
a processor coupled to the memory and the processor configured to
acquire an allocation request for allocating a storage area to a first virtual volume, and
allocate a first storage area to the first virtual volume upon acquiring the allocation request, the first storage area being controlled by a first control device among the plurality of control devices, the first control device controlling the first virtual volume.

2. The storage control device according to claim 1, wherein
the processor is configured to
allocate the first storage area to the first virtual volume when a first already-allocated amount is less than or equal to a predetermined threshold, the first already-allocated amount being an amount of storage areas controlled by the first control device and already allocated to any virtual volumes, and
allocate a second storage area to the first virtual volume when the first already-allocated amount is greater than the predetermined threshold, the second storage area being controlled by a second control device among the plurality of control devices, the second control device receiving an access to the first virtual volume.

3. The storage control device according to claim 2, wherein
the processor is configured to:
allocate a third storage area to the first virtual volume when the first already-allocated amount is greater than the predetermined threshold and when a second already-allocated amount is greater than the predetermined threshold, the second already-allocated amount being an amount of storage areas controlled by the second control device and already allocated to any virtual volumes, the third storage area being controlled by a third control device among the plurality of control devices, the third control device having a third already-allocated amount which is smallest among amounts of storage areas controlled by the respective control devices and already allocated to any virtual volumes.

4. The storage control device according to claim 1, wherein
the processor is configured to
acquire a migration request for migrating first data stored in a second storage area allocated to the first virtual volume, the second storage area being controlled by a second control device among the plurality of control devices, the second control device being different from the first control device,
allocate a third storage area to the first virtual volume upon acquiring the migration request, the third storage area being controlled by the first control device, and
migrate the first data to the third storage area.

5. The storage control device according to claim 1, wherein
the storage areas controlled by the respective control devices are formed by RAID groups each including a plurality of storage devices.

6. A storage system, comprising:
a plurality of control devices each controlling different storage areas, each of the plurality of control devices including:
a memory, and
a processor coupled to the memory and the processor configured to
acquire an allocation request for allocating a storage area to a first virtual volume, and
allocate a first storage area to the first virtual volume upon acquiring the allocation request, the first storage area being controlled by a first control device among the plurality of control devices, the first control device controlling the first virtual volume.

7. A non-transitory computer-readable recording medium having stored therein a program that causes a processor to execute a process, the processor being included in a control device among a plurality of control devices each controlling different storage areas, the process comprising:
acquiring an allocation request for allocating a storage area to a first virtual volume; and
allocating a first storage area to the first virtual volume upon acquiring the allocation request, the first storage area being controlled by a first control device among the plurality of control devices, the first control device controlling the first virtual volume.
